(19) United States
(12) Patent Application Publication
(10) Pub. No.: US 2015/0305417 A1
(43) Pub. Date: Oct. 29, 2015

(54) Molded Auxetic Mesh

(71) Applicant: 3M INNOVATIVE PROPERTIES COMPANY, St. Paul, MN (US)

(72) Inventor: Philip G. Martin, Forest Lake, MN (US)

(21) Appl. No.: 14/792,787

(22) Filed: Jul. 7, 2015

Related U.S. Application Data
(63) Continuation of application No. 12/964,812, filed on Dec. 10, 2010.
(60) Provisional application No. 61/291,057, filed on Dec. 30, 2009.

(51) Int. Cl. A41D 13/11; B32B 5/02; B32B 5/26; A62B 23/02

(52) U.S. Cl. CPC A41D 13/11; A62B 23/025; B32B 5/028; B32B 5/022; B32B 5/26; B32B 2262/0253; B32B 2535/00; B32B 2571/00

(57) ABSTRACT

An article that comprises an auxetic mesh 20 that has been molded into an intended shape. Molded auxetic articles do not distort as much as convention meshes when subjected to the heat and pressure of a molding operation.

### CROSS-REFERENCE To RELATED APPLICATION

This application is a continuation application of U.S. patent application Ser. No. 12/964,812, filed Dec. 10, 2010, that claims the benefit of U.S. Provisional Patent Application No. 61/291,057, filed Dec. 30, 2009.

The present invention pertains to a molded auxetic mesh and to a method of making such a mesh.

### BACKGROUND

Auxetic materials have been made by a variety of methods, including etching, printing, die cutting, and laser cutting. Examples of various patent publications that describe auxetic articles and their methods of production include U.S. 6,878,320B1 to Alderson et al., U.S. 2005/0142331A1 to Anderson et al., U.S. 2005/0159066A1 to Alderson et al., U.S. 2005/0287371A1 to Chaudhari et al., U.S. 2006/0129227A1 to Hengelmolen, U.S. 2006/0180505A1 to Alderson et al., U.S. 2006/0202492A1 to Barvosa-Carter et al., U.S. 2007/0031667A1 to Hook et al. EP1,165,865B1 to Alderson, WO91/01210 to Evans et al., W091/01186 to Ernest et al., WO99/22838 to Alderson et al., WO99/25530 to Lakes et al., W000/53830 to Alderson et al., WO2004/012785A1 to Hengelmolen, WO2004/088015A1 to Hook et al., WO2005/065929A1 to Anderson et al., WO2005/072649A1 to Hengelmolen, WO2006/021763A1 to Hook, WO2006/099975A1 to Wittner, and in M.A. Nkansah et al, Modelling the Effects of Negative Poisson's Ratios in Continuous-Fibre Composites, JOURNAL OF MATERIALS SCIENCE, Vol. 28, 1998, pages 2687-2692, A.P. Pickles et al., The Effects of Powder Morphology on the Processing of Auxetic Polypropylene(PP of Negative Poisson's Ratio), POLYMER ENGINEERING AND SCIENCE, Mid-March 1996, Vo. 36, No. 5, pages 636-642. Although a variety of auxetic articles have been described in the art, the literature has not described the production of molded auxetic meshes.

### SUMMARY OF THE INVENTION

The present invention provides an article that comprises an auxetic mesh that has been molded into an intended shape.

The present invention also provides a method of making a molded article, which method comprises: (a) providing an auxetic mesh; and (b) molding the auxetic mesh into a desired shape.

The inventor discovered that auxetic meshes can be beneficial in that they can be placed into a desired molded shape or configuration with less distortion than non-auxetic meshes. The openings within the mesh, for example, do not vary as much when compared to molded non-auxetic meshes. The different sized openings in conventional molded meshes may be considered unsightly, and portions of the mesh may sometimes overlap and distort during the molding operation. The present invention alleviates such issues and accordingly provides a molded mesh that may be considered to have an improved appearance. There accordingly can be less opportunity for waste when molding an auxetic mesh according to the present invention—as there may be less products that are discarded due to manufacturing defects. Molded auxetic meshes may be suitable for use in filtering face-piece respirators and in a variety of other products where molded meshes are used. Molded auxetic meshes also may find new applications where the auxetic properties play a beneficial role.

### GLOSSARY

The terms set forth below will have the meanings as defined:

“auxetic” means exhibiting a negative Poisson's ratio;

“comprises (or comprising)” means its definition as is standard in patent terminology, being an open-ended term that is generally synonymous with “includes”, “having”, or “containing” Although “comprises”, “includes”, “having”, and “containing” and variations thereof are commonly-used, open-ended terms, this invention also may be suitably described using narrower terms such as “consists essentially of”, which is semi open-ended term in that it excludes only those things or elements that would have a deleterious effect on the performance of the inventive subject matter;

“mesh” means a structure that has a network of open spaces and that is substantially larger in first and second dimensions than in a third;

“molded” or “molding” means forming into a desired shape using heat and pressure;

“multitude” means 100 or more;

“polymer” means a material that contains repeating chemical units, regularly or irregularly arranged;

“polymeric” and “plastic” each mean a material that mainly includes one or more polymers and that may contain other ingredients as well;

“plurality” means two or more;

“respirator” means an air filtration device that is worn by a person to provide the wearer with clean air to breathe; and

“support structure” means a construction that is designed to have sufficient structural integrity to retain its desired shape and to help retain the intended shape of the filtering structure that is supported by it.

### BRIEF DESCRIPTION OF THE DRAWINGS

FIG. 1 shows a front perspective view of a filtering face-piece respirator 10 that uses a molded auxetic mesh 20 of the present invention;

FIG. 2 is an enlarged view of the region circled in FIG. 1;

FIG. 3 is a cross-section of the mask body 12 taken along lines 3-3 of FIG. 1;

FIG. 4 is a schematic view of an apparatus 50 for making an auxetic mesh 20;

FIG. 5 is an enlarged view of the casting of the extruded polymeric material 60 onto a casting roll 58;

FIG. 6 is a perspective view of the casting roll 58 that may be used to make an auxetic mesh;

FIG. 6a is an enlarged area of the outer surface of the casting roll 58;

FIG. 7 is a plan view of a mold that may be used in connection with the present invention; and

FIG. 8 is a front view of an auxetic mesh 20 that may be used in making a molded article in connection with the present invention.

### DETAILED DESCRIPTION OF PREFERRED EMBODIMENTS

In practicing the present invention, an auxetic mesh can be molded into a desired three-dimensional configuration. The inventor discovered that the a molded auxetic mesh can be formed into a desired 3-D shape while preserving the size of the various open spaces in the mesh. As the auxetic mesh attains its three-dimensional shape during molding, the mesh deforms in a fractal manner, substantially retaining the initial mesh appearance, unlike the distortions observed after conventional meshes are formed over bi-curved surfaces. Before being molded, the auxetic mesh may be provided in an initial flat two-dimensional form, which is simple to handle and store. Converting the initial flat auxetic mesh into a three-dimensional shape may provide a more efficient manufacturing pathway when compared to batch processes that would normally required to fabricate a similar netting substantially free of defects. That is, if a non-auxetic mesh is used to produce a three-dimensional product, without the distortions mentioned above, a batch-type casting or injection molding process typically would be used for that purpose.

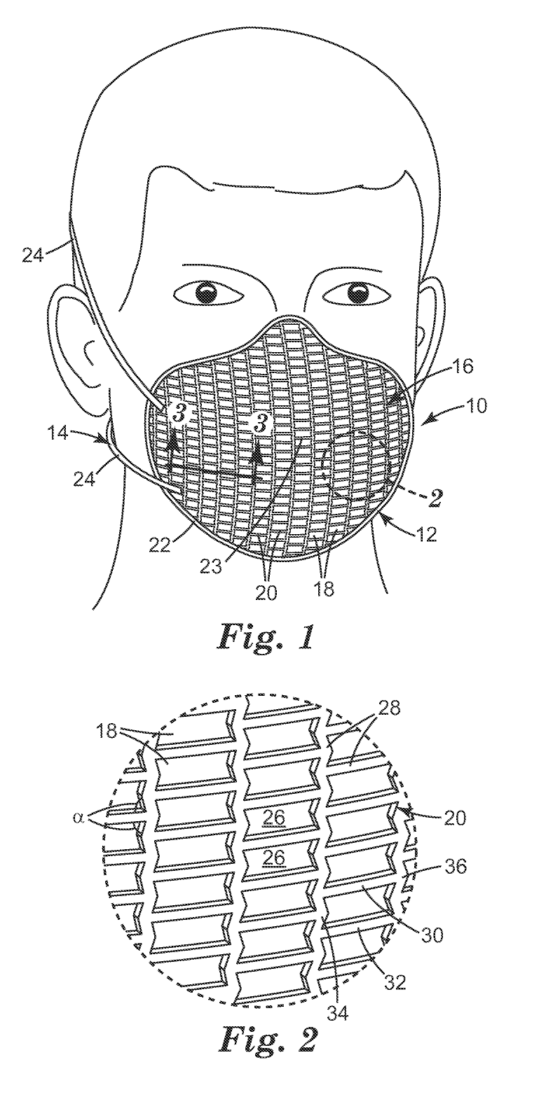

FIG. 1 shows an example of a molded product, a filtering face-piece respirator 10, that uses a molded auxetic mesh to provide a three-dimensional shape to the product. The filtering face-piece respirator 10 includes a mask body 12 and a harness 14. The mask body 12 has a support structure 16 that provides structural integrity to the mask body and that provides support for a filtering structure 18 that resides behind the support structure 16. The filtering structure 18 removes contaminants from the ambient air when a wearer of the respirator 10 inhales. The support structure 16 includes an auxetic mesh 20 that is molded into a three-dimensional configuration, which defines the shape of the mask body 12. The molded auxetic mesh 20 can provide the structural integrity sufficient for the mask body 12 to retain its intended configuration. The filtering structure 18 may be secured to the support structure 16 at the mask body perimeter 22. The filtering structure 18 also may be secured to the support structure 16 at the apex 23 of the mask body when an exhalation valve (not shown) is secured thereto. The harness 14 may include one or more straps 24 that enable the mask body 12 to be supported over the nose and mouth of a person. Adjustable buckles may be provided on the harness to allow the straps 24 to be adjusted in length. Fastening or clasping mechanisms also may be attached to the straps to allow the harness 14 to be disassembled when removing the respirator 10 from a person's face and reassembled when donning the respirator 10 from a person's face. Further, description of the filter face-piece respirator may be found in U.S. patent application Ser. No. 61/291,052 entitled Filtering Face-Piece Respirator Having An Auxetic Mesh In The Mask Body.

FIG. 2 shows an enlarged view of the open-work auxetic mesh 20, which may be used in connection with the present invention. As illustrated, the molded auxetic mesh 20 includes a multitude of open spaces 26 that may be defined by polymeric strands 28. The strands 28 that define each open space 26 may include first and second sides 30 and 32 and third and fourth sides 34 and 36. The first and second sides 30 and 32 may be linear, whereas the third and fourth sides 34 and 36 may be non-linear and include segments that are offset non-perpendicularly to the first and second sides 30 and 32. The offset segments do not form right angles to the first and second sides 30 and 32. Rather, they form a chevron end that has angles a that may be about 20 to 80 degrees, more typically about 40 to 70 degrees. Each opening typically has a size of about 5 to 50 square millimeters (mm²), more typically about 10 to 35 mm². Other auxetic mesh geometries (now known or later developed) also may be suitably used in connection with the present invention. The Poisson ratio of the mesh typically is less than −0.2, more typically less than −0.4, and still more typically less than −0.7, but usually is not further less than −2.2. Examples of meshes that exhibit negative Poisson ratios and that may be suitable for use in connection with the present invention are described in U.S. Patent Application Publication 2006/0129227A2 to Hengelmolen and 2006/0180505A1 to Alderson et al. At the upper end, the Poisson ratio is not greater than zero. The multitude of openings in the mesh, after being molded, tend to maintain similar sizes. When tested according to the Cell Size Determination method described below, the standard deviation of cell sizes is less than 0.04, 0.03, and even less than 0.025.

FIG. 3 shows a cross-section of the mask body 12, which includes the support structure 16 and the filtering structure 18. The support structure 16 typically has a thickness of about 0.60 to 0.85 millimeters (mm), and each strand 28 typically has an average cross-sectional area of about 0.1 to 3.5 mm², more typically of about 1.5 to 2.6 mm². The auxetic mesh 20 may be made from a variety of polymeric materials. Polymers suitable for auxetic mesh formation are generally either a thermoplastic or a thermoset material. Thermoplastic materials are materials which melt and/or flow upon the application of heat, resolidify upon cooling and again melt and/or flow upon the application of heat. The thermoplastic material undergoes only a physical change upon heating and cooling, no appreciable chemical change occurs. Thermoset materials, however, are curable materials that irreversibly cure, such as becoming crosslinked, when heated or cured. Once cured, the thermoset material will not appreciably melt or flow upon application of heat.

Examples of thermoplastic polymers that can be used to form auxetic meshes include: polyolefins, such as polyethylenes, polypropylenes, polybutylenes, blends of two or more of such polyolefins, and copolymers of ethylene and/or propylene with one another and/or with small amounts of copolymerizable, higher, alpha olefins, such as pentene, methylpentene, hexene, or octene; halogenated polyolefins, such as chlorinated polyethylene, poly(vinylidene fluoride), poly(vinylidene chloride), and plasticized poly(vinyl chloride); copolyester-ether elastomers of cyclohexane dimethanol, tetramethylene glycol, and terephthalic acid; copolyester elastomers such as block copolymers of polybutylene terephthalate and long chain polyester glycols; polyethers, such as polyphenyleneoxide; polyamides, such as poly(hexamethylene adipamide), e.g., nylon 6 and nylon 6,6; nylon elastomers; such as nylon 11, nylon 12, nylon 6,10 and polyether block polyamides; polyurethanes; copolymers of ethylene, or ethylene and propylene, with (meth)acrylic acid or with esters of lower alkanols and ethylenically-unsaturated carboxylic acids, such as copolymers of ethylene with (meth)acrylic acid, vinyl acetate, methyl acrylate, or ethyl acrylate; ionomers, such as ethylene-methacrylic acid copolymer stabilized with zinc, lithium, or sodium counterions; acrylonitrile polymers, such as acrylonitrile- butadiene-styrene copolymers; acrylic copolymers; chemically-modified polyolefins, such as maleic anhydride- or acrylic acid- grafted homo-or co-polymers of olefins and blends of two or more of such polymers, such as blends of polyethylene and poly(methyl acrylate), blends of ethylene-vinyl acetate copolymer and ethylene-methyl acrylate; blends of polyethylene and/or polypropylene with poly(vinyl acetate); and thermoplastic elastomer block copolymers of styrene of the A-B or A-B-A type, where A represents a thermoplastic polystyrene block and B represents a rubbery block of polyisoprene, polybutadiene, or poly(ethylene/butylene), examples include linear, radial, star and tapered styrene-isoprene block copolymers, linear styrene-(ethylene-butylene) block copolymers, and linear, radial, and star styrene-butadiene block copolymers. The foregoing polymers are normally solid, generally high molecular weight, and melt-extrudable such that they can be heated to form molten viscous liquids which can be pumped as streams to the extrusion die assembly and readily extruded therefrom under pressure.

Examples of suitable commercially-available polymers include: those sold as “ELVAX” ethylene-vinyl acetate copolymers, such as ELVAX 40W, 4320, 250, and 350; those sold as “EMAC” ethylene-methyl acrylate copolymers, such as EMAC DS-1274, DS-1176, DS-1278-70, SP 2220 and SP-2260; those sold as “VISTA FLEX” thermoplastic elastomers, such as VISTA FLEX 641 and 671; those sold as “PRIMACOR” ethylene-acrylic acid copolymers, such as PRIMACOR 3330, 3440, 3460, and 5980; those sold as “FUSABOND” maleic anhydride-polyolefin copolymers, such as FUSABOND MB-110D and MZ-203D; those sold as “HIMONT” ethylene-propylene copolymers, such as HIMONT KS-057, KS-075, and KS-051P; those sold as “FINA” polypropylenes, such as FINA 3860X; those sold as “ESCORENE” polypropylenes, such as ESCORENE 3445; the polymer sold as “VESTOPLAST 750” ethylene-propylene-butene copolymer; those sold as “SURLYN” ionomers, such as SURLYN 9970 and 1702; those sold as “ULTRAMID” polyamides, such as ULTRAMID B3 nylon 6 and ULTRAMID A3 nylon 6,6; those sold as “ZYTEL” polyamides, such as ZYTEL FE3677 nylon 6,6; those sold as “RILSAN” polyamide elastomers, such as BMNO P40, BESNO P40 and BESNO P20 nylon 11; those sold as “PEBAX” polyether block polyamide elastomers, such as PEBAX 2533, 3533, 4033, 5562 and 7033; those sold as “HYTREL” polyester elastomers, such as HYTREL 3078, 4056 and 5526; those sold as “KRATON” and “EUROPRENE SOL TE” styrene block copolymers, such as KRATON D1107P, G1657, G1750X, and D1118X and EUROPRENE SOL TE 9110,and 6205.

As mentioned above, blends of two or more materials also may be used in the manufacture of auxetic meshes. Examples of such blends include: a blend of 85 to 15 wt % poly(ethylene-vinyl acetate), such as “ELVAX” copolymer, with 15 to 85 wt % poly(ethylene-acrylic acid), such as “PRIMACOR” polymer, the poly(ethylene-vinyl acetate) component of the blend generally will have a weight average molecular weight, Mw, of 50,000 to 220,000 and will have 5 to 45 mol % of its interpolymerized units derived from the vinyl acetate comonomer and the balance of units from ethylene, the poly(ethylene-acrylic acid) component of the blend generally will have a Mw of 50,000 to 400,000 and have 1 to 10 mol % of its interpolymerized units derived from acrylic acid and the balance from ethylene; a blend of 20 to 70 wt % poly(ethylene-propylene-butene) terpolymer having Mw of 40,000 to 150,000 and derived from equally large amounts of butene and propylene and a small amount of ethylene, such as “VESTOPLAST 750” polymer, with 80 to 30 wt % isotactic polypropylene; a blend that contains from 15 to 85 wt % poly(ethylene-vinyl acetate) and 85 to 15 wt % poly(ethylene-methyl acrylate), such as “EMAC” polymer, the poly(ethylene-vinyl acetate) component of this blend can have a molecular weight and composition like that described above, the poly(methyl acrylate) component can have a Mw of 50,000 to 200,000 and 4 to 40 mole % of its interpolymerized units derived from the methyl acrylate comonomer.

Polypropylene may be preferred for use in a molded auxetic mesh that is used on a respirator to enable proper welding of the support structure to the filtering structure (filtering layers often comprise polypropylene as well). The polymeric materials used to make an auxetic mesh typically have a Young's modulus of about 0.3 to 1900 Mega Pascals (MPa), more typically 2 to 250 MPa. As shown in FIG. 3, the filtering structure 18 may include one or more cover webs 40a and 40b and a filtration layer 42. The cover webs 40a and 40b may be located on opposing sides of the filtration layer 42 to capture any fibers that could come loose therefrom. Typically, the cover webs 40a and 40b are made from a selection of fibers that provide a comfortable feel, particularly on the side of the filtering structure 18 that makes contact with the wearer's face. The cover webs too often comprise polypropylene.

When molding an auxetic mesh in accordance with the present invention, the auxetic mesh may be molded by itself or it may be molded in conjunction with other layers. For example, when making a filtering face-piece respirator, the auxetic mesh may be first molded, and the other layers, such as the filtering structure, may be subsequently joined to the molded mesh. Alternatively, the various layers may be stacked together and molded into the desired configuration. Further, the auxetic mesh may be cold-molded or hot-molded. When the auxetic mesh is cold-molded, the mesh is first heated before being placed between unheated molding members (see, for example, U.S. Pat. No. 7,131,422B1 to Kronzer et al.). The unheated molding members then conform the heated auxetic mesh to its desired configuration. Alternatively, the molding members may be heated, and that heat may be transferred to the auxetic mesh during the molding operation. Thus, in a cold-molding operation, the heat and pressure are not necessarily applied to the auxetic mesh contemporaneously, whereas in a hot-molding operation the heat and pressure tend to be applied at the same time. In hot molding, the various layers may become bonded to each other at one or more desired locations when the heat and pressure is applied. Alternatively, the various layers may be joined together at one or more desired locations through other operations such as welding (for example, ultrasonic welding) or adhesive bonding. The additional layers may be on one or both sides of the auxetic mesh. When making a filtering face-piece respirator, the mask body may be molded into a variety of different shapes and configurations. Many of these various shapes and configurations are described in the patent literature and accordingly will not be discussed further here.

### EXAMPLES

### Cell Size Determination

Auxetic mesh cell size was determined using defined diameter rods that were mounted in a fixture to facilitate measurement of the open spaces or cells. The probe rods ranged in diameter from 0.0254 cm (centimeter) to 0.5334 cm, in 0.0254 cm increments. The cell size was measured by selecting the maximum size probe that fit into the cell without causing distortion of the cell shape prior to placement of the probe. This size was recorded, and the next cell size was measured and recorded until all cells contained within the molded mesh were measured and the cells tallied at each probe size.

### Auxetic Mesh Formation Apparatus and Process

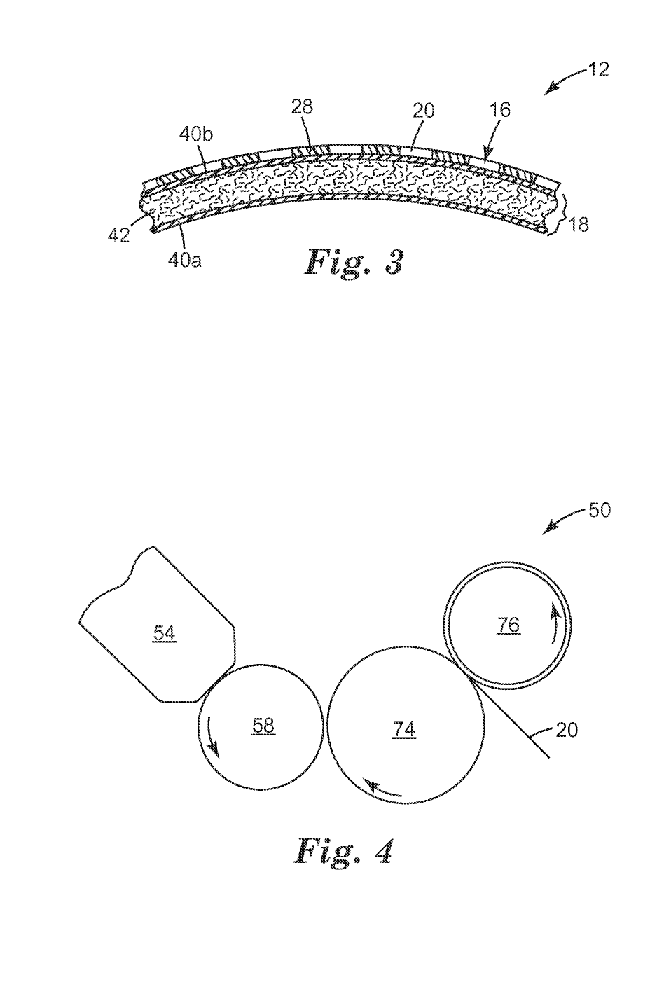

An auxetic web was produced using a system 50 that resembles the apparatus shown in FIG. 4. A 40 mm diameter twin-screw extruder was fitted with a gear pump and was used to deliver a molten polymer blend at melt temperature of approximately 246° C. to a slot die 54, at an extrusion rate of 1.43 kg/hr/cm (kilogram per hour per length of die in centimeters). The polymer blend contained a three-part polymer composition that included pigment and anti-block agents. The polymer blend formulation is given below in Table 1. At the end of the slot die 54, the polymer blend is transferred to a casting roll 58 where the auxetic mesh is formed. The resulting mesh 20 is removed from the casting roll 58 where it is transferred to take-off roll 74. A back-up roll 76 contacts the take-off roll 74 to keep the auxetic mesh on the take-off role until the point of departure from the roll.

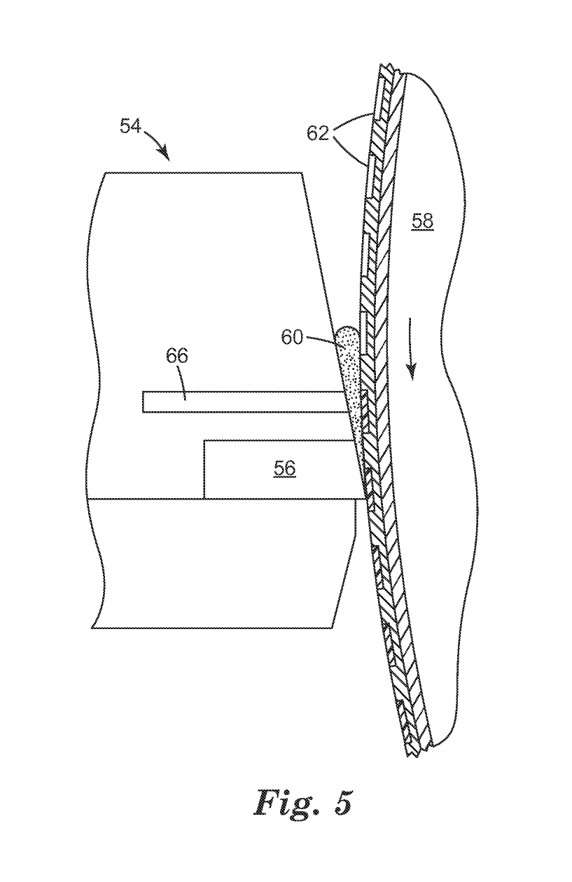

FIG. 5 shows the orientation of the slot die 54, doctor blade 56, and casting roll 58 in greater detail. The slot die 54 was maintained at a temperature of about 246° C. and was positioned relative to the casting roll 58 such that a bank 60 of molten polymer was formed along a horizontal plane. The molten polymer 60 was forced into the casting roll cavity 62 by rotating the casting roll 58 against the doctor blade 56. The doctor blade 56 both forced molten polymer 60 into the casting roll cavity 62 and wiped the outer surface 64 of the casting roll 58 so that the molten polymer 60 was left in the cavity alone. Polymer that was removed from the polymer bank 60 via the casting roll 58 was replenished through the resin channel 66 of the slot die 54. By this process, the auxetic mesh was continually casted.

TABLE 1
Polymer Blend Composition

| Weight | Material | | | Supplier |
|---|---|---|---|---|
| Percent | Type | Trade Name | Supplier | location |
| 41% | Olefin | Engage 8490 | DuPont Dow | Wilmington, |
| | Elastomer | | Elastomers LLC. | Delaware |
| 41% | LLDPE | Hypel ™ LLDPE | Entec Polymers, | Houston, |
| | | 52 | LLC | Texas |
| 15% | SEBS | Kraton G1657 | Kraton Polymers | Houston, |
| | | | LLC | Texas |
| 3% | LDPE | Yellow Pigment | Clariant | Chicago, Ill |
| | | compounded | Masterbatches | |
| | | with Atmer 1753 | | |
| | | Erucamide | | |
| | | (Loading | | |
| | | indicated an next | | |
| | | line) | | |
| 0.12% | Erucamide | Atmer 1753 | Unichema North | Minneapolis, |
| | | | America | MN |

During processing, the doctor blade 56 was forced against the rotating casting roll 58 at a pressure of 0.656 kN/cm (kilo-Newtons per lineal cm)—a pressure that forced molten polymer 60 to fill the channels or cavities 62 of the casting roll 58. The doctor blade 56 was maintained at a temperature of 246° C. The polymer bank 60 assured that sufficient polymer was present across the transverse length of the casting roll 58 to fill the channels 62 of the casting roll.

As shown in FIG. 4, the apparatus 50 used a two-roll transfer system, which was composed of a chrome take-off roll 74 and a rubber-surfaced backup role 76, to extract the cast auxetic mesh 20 from the casting roll 58 and convey it to a collection apparatus. The takeoff role 74 contacted the casting roll 58 at a point 225° degrees counter clockwise (the direction of rotation) from the point of contact between the slot die 54 and casting roll 58. The backup roll 76 contacted the take-off roll 74 it a point 135° degrees clockwise (direction of rotation) from the point of contact between the casting roll 58 and take-off roll 74. Both rolls were maintained at a temperature of approximately 4.4° C. and had surface speeds of 5.0 m/min (meters per minute). The nip pressure between the casting roll 58 and take-off roll 74 was maintained at 4.37 N/cm; the nip pressure between the take-off roll 74 and the backup role 76 was 4.37 N/cm. After leaving the casting roll, the auxetic mesh 20 was transferred to the take-off roll 74 and was further cooled and conveyed through web handling rolls to a windup roll (not shown). The resulting mesh had a thickness of about 1.63 mm and a basis weight of 47 g/cm² (grams per square centimeter). The final wound roll of auxetic mesh contained an intermittent thin film of polymeric material between each of the auxetic pattern elements. All residual inter-element film was removed by hand using a tweezers. Other methods of residual film removal could include burning, heating, brushing, punching, etc.

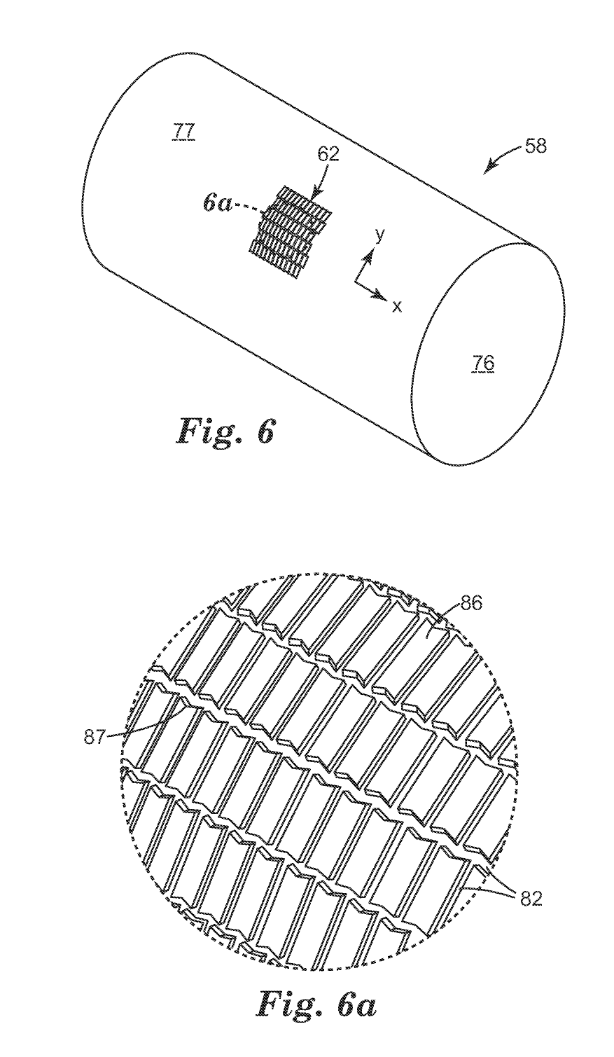

As shown in FIGS. 6 and 6a, the casting roll 58 had an auxetic-shaped cavity pattern 62 machined into its face. The cavity pattern 62 was cut into the face 77 of a 23.5 cm diameter, chrome-surfaced, steel roll 58. The auxetic-shaped pattern 62 of interconnecting channels 82 was machined into the face 77 of the casting roll 58 using a Harvey Tool #11815-30 Carbide Miniature Tapered End Mill, Harvey Tool Company LLC, Rowley, Mass. having a 6° included angle. The channels 82 of the auxetic pattern 62 were machined to a depth of 1.143 mm, with the rectangular channel formed by 3° tapered edge. The channels 82 are defined by uncut “island” areas 86 in the roll face 77, whereby the machined area constituted the channels 82. The unmachined islands 86 on the roll face 84, onto which the doctor blade 56 rides during mesh formation, were the shape of elongated hexagons that had isosceles concave ‘chevron’ ends 87.

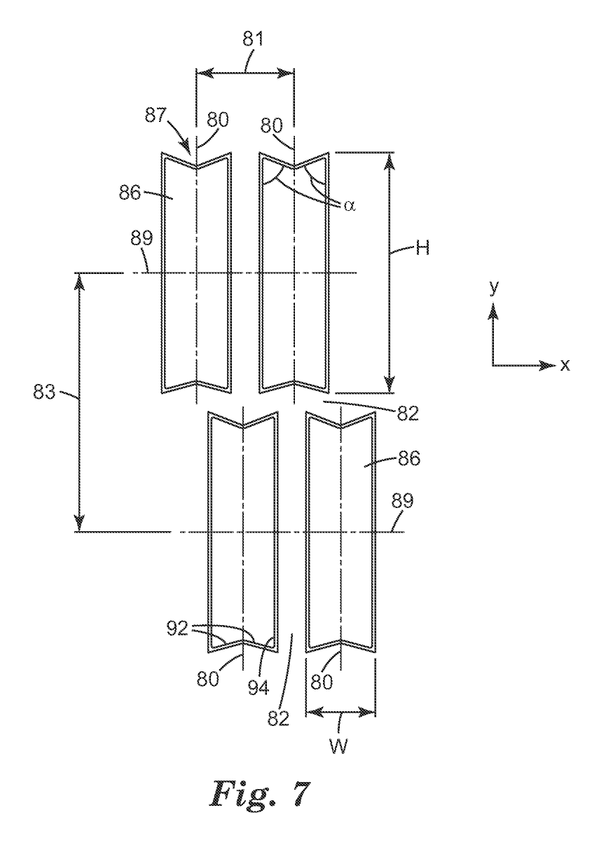

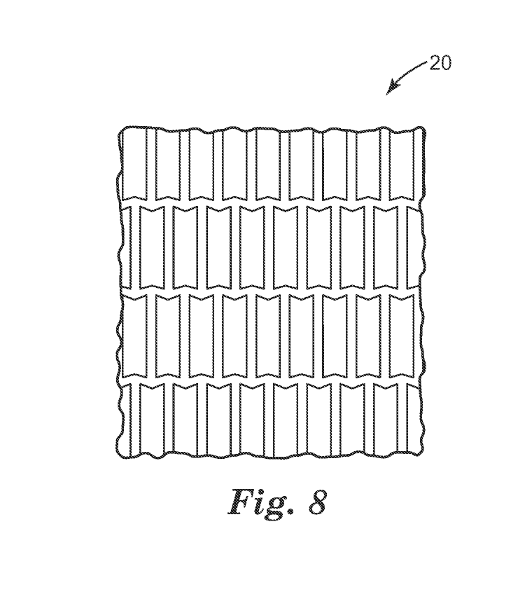

As shown in FIG. 7, islands 86 were oriented on the roll 76 such that their long axis 80 aligned with the circumstantial line of the roll 76. The islands 86 had an overall height H and width W of 11.1 mm and 3.1 mm, respectively. Two equally length lines, 92 extending 1.67 mm from the ends of each major side 94 of the hexagon, and meeting at its long axis centerline 80, formed the end chevron 87 of an island 86. Islands were spaced apart, relative to their centerlines, either along their long axis 80 or narrow (short) axis 89. The long axes of all islands were parallel to the circumstantial line of the casting roll 76. The narrow axes 89, of the islands were oriented along the axis of the casting roll 58. Alternating transverse rows of islands were offset from the row above or below by one half the width of each island. Transverse spacing of the islands 81 was 4.27 mm from long axis 80 to an adjacent long axis 80. Circumstantial spacing 83 of the islands was 11.88 mm from short axis 89 to short axis 89. Angle α was 69 degrees. With the islands 86 formed in this manner, a network of channels 82 was created; these channels 82 were filled with polymer during the casting process and acted as molds for the auxetic mesh 20. FIG. 8 shows an image of the molded auxetic mesh 20 produced as described above.

### Auxetic Mesh Characterization Test Method

Auxetic mesh produced as described in the Auxetic Mesh Formation Apparatus and Process were evaluated for their auxetic properties through a tensile testing procedure. In this procedure, a 10.2 cm by 1.0 cm section of mesh was cut such that the long axes of the mesh cells were oriented in line with the transverse axis of the tensile testing apparatus. The crosshead speed of the tensile testing apparatus was maintained at 50.8 centimeters per minute until the sample was elongated to 50 and 100 percent of its original length. As is indicative of an auxetic structure, when placed under tension, the sample section increased in width in response to axial loading. The sample increased to a width of 105 percent of its original width at both elongations.

### Three-Dimensional Molding of an Auxetic Mesh

Auxetic mesh produced as described in the Auxetic Mesh Formation Apparatus and Process section was molded into a three-dimensional cup shape. The auxetic mesh was molded into the cup shape of a respirator by draping a 21.5 cm by 25.5 cm section of mesh over an aluminum male mold. The mold had a generally hemispherical shape with an elliptical base with a major axis of 13.3 cm, and a minor axis of 10.5 cm, and a dome height of 4.4 cm. The hemispherical-shape mold was fixed to a rectangular aluminum plate that extended approximately 3.4 cm beyond the base of the mold. The section of auxetic mesh was draped over the mold so that it's edges extended beyond the outer perimeter of the base plate. A perimeter aluminum frame, with an interior cutout that mirrored the perimeter of the mold, was placed over the auxetic mesh and mold so that the mesh could be drawn over the mold without significant mesh distortion. The perimeter frame was then fixed to the base plate to hold the mesh in position against the mold. The mold, mesh, and securing plate assembly was placed in a preheated, air circulating oven for 20 minutes at a temperature of 105 C. After heating in the oven for the specified duration, the assembly was removed from the oven and was allowed to cool to room temperature. When the assembly reached room temperature, the perimeter frame was uncoupled from the base plate, and the resultant molded auxetic mesh removed from the mold. It was observed that the molded auxetic mesh retained its general auxetic structure, and it was shape-retaining even after compression in the mold. It was also noted that the auxetic mesh was able to easily adapt to the male mold shape without significant distortions to the mesh, such as folds or creases.

### Respirator Cell Size Comparison

A respirator shell mesh was produced as described above in the Three-Dimensional Molding of Auxetic Mesh section was evaluated for cell size uniformity by surveying the size of the cells over the entirety of the mold structure. The cell size uniformity of the auxetic mesh was compared to the uniformity of shell meshes that were removed from commercially available filtering face-piece respiratory masks. Detailed measurements of the cell opening size and size distribution for each of several shell meshes were determined. Respirator shell mesh was evaluated from a JSP 822 mask, manufactured by JSP Ltd, Oxfordshire, UK; a Venus 190 mask, produced by Nani Mumbai-MN, India; a 2200 mask inner shell, a 2200 mask outer shell, and a 2600 outer shell, all manufactured by Moldex-Metric, Culver City, Calif. The meshes were removed from the filter media to enable cell size measurement, the exception being the 3M auxetic mesh which was free standing. Each cell opening size was measured and recorded for the entire mesh using gauging probes as described above in Cell Size Determination.

The resulting measurements were compiled to provide the number of cells contained within the mesh of a given size, see Table 2. From this data the cell size distribution and standard deviation determined were determined and are given in Table 2.

TABLE 2
Cell Size Distribution

| | | | Moldex | Moldex | Moldex | Molded |
|---|---|---|---|---|---|---|
| Probe | JSP | Venus | 2200 | 2600 | 2200 | Auxetic |
| Size(cm) | 822 | 190 | Inner Shell | Outer Shell | Outer Shell | Mesh |
| 0.0254 | 1 | 1 | 0 | 1 | 2 | 0 |
| 0.0508 | 4 | 0 | 3 | 5 | 3 | 0 |
| 0.0762 | 3 | 0 | 2 | 5 | 5 | 0 |
| 0.1016 | 25 | 2 | 7 | 10 | 8 | 0 |
| 0.127 | 51 | 5 | 6 | 24 | 10 | 0 |
| 0.1524 | 92 | 7 | 14 | 20 | 34 | 0 |
| 0.1778 | 99 | 32 | 22 | 70 | 43 | 2 |
| 0.2032 | 96 | 32 | 22 | 77 | 81 | 11 |
| 0.2286 | 82 | 36 | 50 | 164 | 192 | 54 |
| 0.254 | 68 | 57 | 48 | 194 | 116 | 99 |
| 0.2794 | 66 | 162 | 77 | 286 | 88 | 222 |
| 0.3048 | 45 | 320 | 101 | 243 | 93 | 25 |
| 0.3302 | 49 | 135 | 106 | 27 | 104 | 0 |
| 0.3556 | 15 | 4 | 119 | 0 | 92 | 0 |
| 0.381 | 2 | 0 | 74 | 0 | 34 | 0 |
| 0.4064 | 0 | 0 | 62 | 0 | 32 | 0 |
| 0.4318 | 0 | 0 | 35 | 0 | 2 | 0 |
| 0.4572 | 0 | 0 | 28 | 0 | 1 | 0 |
| 0.4826 | 0 | 0 | 16 | 0 | 0 | 0 |
| 0.508 | 0 | 0 | 5 | 0 | 0 | 0 |
| 0.5334 | 0 | 0 | 0 | 0 | 0 | 0 |
| Standard | 0.0676 | 0.0444 | 0.0814 | 0.0510 | 0.0708 | 0.0234 |
| Deviation | | | | | | |

The data shown in Table 2 reveals that the molded auxetic mesh has the narrowest distribution of cell size compared to known non-auxetic molded meshes. Analysis of the data for standard deviation shows that the inventive auxetic mesh has the smallest standard deviation of all six meshes measured. The reduction of cell size distribution in the auxetic mesh is a result of the deformation characteristics of an auxetic structure, which allows it to more readily conform to highly contoured shapes without gross deformation of the mesh, such as folding or drawing.

1-23. (canceled)

24. A filtering face-piece respirator that comprises:
a harness; and
a mask body that comprises:
a filtering structure that comprises a filtration layer; and
a support structure that comprises an auxetic mesh that has been molded into an intended shape.

25. The filtering face-piece respirator of claim 24, wherein the mesh is molded into a cup shape.

26. The filtering face-piece respirator of claim 24, wherein the auxetic mesh includes a multitude of open spaces that are defined by first and second sides and third and fourth sides, wherein the first and second sides are linear and wherein the third and fourth sides are non-linear and include segments that are offset non-perpendicularly to the first and second sides.

27. The filtering face-piece respirator of claim 26, wherein the offset segments reside at an angle α of about 20 to 80 degrees from the linear first and second sides.

28. The filtering face-piece respirator of claim 27, wherein angle α is about 40 to 70 degrees.

29. The filtering face-piece respirator of claim 24, wherein the auxetic mesh comprises a multitude of openings that have a size of 5 to 50 square millimeters.

30. The filtering face-piece respirator of claim 29, wherein the openings have a size of 10 to 35 square millimeters.

31. The filtering face-piece respirator of claim 24, wherein the auxetic mesh exhibits a Poisson ratio of less than −0.2.

32. The filtering face-piece respirator of claim 24, wherein the auxetic mesh exhibits a Poisson ratio of less than −0.4.

33. The filtering face-piece respirator of claim 24, wherein the auxetic mesh exhibits a Poisson ratio of less than −0.7.

34. The filtering face-piece respirator of claim 33, wherein the auxetic mesh exhibits a Poisson ratio that is not further less than −2.2.

35. The filtering face-piece respirator of claim 24, wherein the auxetic mesh has a thickness of about 0.6 to 0.85 millimeters.

36. The filtering face-piece respirator of claim 24, wherein the auxetic mesh comprises strands that have an average cross-sectional area of about 0.1 to 3.5 square millimeters.

37. The filtering face-piece respirator of claim 24, wherein the auxetic mesh comprises strands that have an average cross-sectional area of about 1.5 to 2.6 square millimeters.

38. The filtering face-piece respirator of claim 24, wherein the auxetic mesh comprises polypropylene.

39. The filtering face-piece respirator of claim 24, wherein the auxetic mesh comprises a polymeric material that has a Young's modulus of about 0.3 to 1900 Mega Pascals.

40. The filtering face-piece respirator of claim 24, wherein the auxetic mesh comprises a polymeric material that has a Young's modulus of about 2 to 250 Mega Pascals.

41. The filtering face-piece respirator of claim 24, wherein the molded auxetic mesh exhibits a cell size distribution that has a standard deviation of less than 0.04.

42. The filtering face-piece respirator of claim 24, wherein the molded auxetic mesh exhibits a cell size distribution that has a standard deviation of less than 0.03.

43. The filtering face-piece respirator of claim 24, wherein the molded auxetic mesh exhibits a cell size distribution that has a standard deviation of less than 0.025.
